(19) United States
(12) Patent Application Publication
(10) Pub. No.: US 2025/0332927 A1
(43) Pub. Date: Oct. 30, 2025

(54) BATTERY SYSTEM FOR AN INDUSTRIAL VEHICLE

(71) Applicant: Crown Equipment Corporation, New Bremen, OH (US)

(72) Inventors: Markus Josef Ranhart, Dachau (DE); Stefan Peter Hannemann, Munich (DE); Ludwig Möglinger, Hoehenkirchen-Siegertsbrunn (DE)

(21) Appl. No.: 19/187,224

(22) Filed: Apr. 23, 2025

Related U.S. Application Data
(60) Provisional application No. 63/639,182, filed on Apr. 26, 2024.

(51) Int. Cl. B60L 50/60; B66F 9/075; H01M 50/249

(52) U.S. Cl. CPC B60L 50/60; B66F 9/07531; B66F 9/0755; H01M 50/249; B60L 2200/42; H01M 2220/20

(57) ABSTRACT

A battery system for an industrial vehicle, the industrial vehicle including a frame having a vehicle contour defined by front, back, left, and right bounds of the frame, the left and right bounds at least partially defined by opposed outermost left and right portions of respective left and right sides of a battery compartment. The battery system includes a battery, and a counterweight assembly, wherein at least a portion is positioned underneath the battery. The battery system further includes a first sensor assembly positioned underneath the battery at one of the left or right side of the battery compartment. The first sensor assembly is completely located within the front, back, left, and right bounds of the frame so as to not increase the vehicle contour. The first sensor assembly includes a sensing device that monitors an area adjacent to the corresponding left or right side of the vehicle.

### CROSS REFERENCE TO RELATED APPLICATION

This application claims the benefit of U.S. Provisional Patent Application Ser. No. 63/639,182, filed Apr. 26, 2024, entitled “BATTERY SYSTEM FOR AN INDUSTRIAL VEHICLE”, attorney docket 2202/CRN 1058 MA, the entire disclosure of which is hereby incorporated by reference herein.

### FIELD

The present disclosure relates to a battery system for use with an industrial vehicle.

### BACKGROUND

Industrial vehicles are commonly used for picking stock in warehouses and distribution centers. Such vehicles typically include a power unit, which may include a battery system. The vehicle also has control structures for controlling operation and movement of the vehicle.

In a typical stock picking operation, an operator fills orders from available stock items that are located in storage areas provided along one or more aisles of a warehouse or distribution center. It is advantageous for the industrial vehicle to be sized such that it fits properly in the aisles of the warehouse or distribution center.

### BRIEF SUMMARY

In accordance with various aspects of embodiments, a battery system for an industrial vehicle is disclosed. The industrial vehicle includes a frame having a vehicle contour defined by front, back, left, and right bounds of the frame, the left and right bounds at least partially defined by opposed outermost left and right portions of respective left and right sides of a battery compartment. The battery system comprises a battery housed in the battery compartment and a counterweight assembly, wherein at least a portion thereof is positioned underneath the battery. The system further includes a first sensor assembly positioned underneath the battery at one of the left or right side of the battery compartment, wherein the first sensor assembly is completely located within the front, back, left, and right bounds of the frame so as to not increase the vehicle contour. The first sensor assembly includes a sensing device that monitors an area adjacent to the corresponding left or right side of the vehicle.

The battery may be a replacement battery that is smaller in at least one of a height, width, or depth dimension than an original equipment manufacturer (OEM) battery which the replacement battery is used to replace.

The counterweight assembly may include a first cutout portion for receiving the first sensor assembly, wherein the first cutout portion allows for manipulation of the first sensor assembly without removing the battery or the counterweight assembly from the industrial vehicle.

The battery system may further comprise a second sensor assembly positioned underneath the battery at the other of the left or right side of the battery compartment, wherein the second sensor is completely located within the front, back, left, and right bounds of the frame so as to not increase the vehicle contour. The second sensor assembly may include a sensing device that monitors an area adjacent to the corresponding left or right side of the vehicle.

The counterweight assembly may include a first cutout portion for receiving the first sensor assembly and a second cutout portion for receiving the second sensor assembly. The first and second cutout portions allow for manipulation of the first sensor assembly and the second sensor assembly without removing the battery or the counterweight assembly from the industrial vehicle.

A height of an operator compartment floorboard above a floor surface may be the same before and after the battery is installed in the vehicle.

The system may further include a front sensor assembly and a rear sensor assembly. The front and rear sensor assemblies, together with the first and second sensor assemblies, may comprise a vehicle sensor assembly.

The vehicle sensor assembly may be provided for monitoring 360 degrees around the vehicle.

In accordance with various aspects of embodiments, an object detection assembly for an industrial vehicle is disclosed. The industrial vehicle includes a battery compartment, a replacement battery that is smaller in at least one of a height, width, or depth dimension than an original equipment manufacturer (OEM) battery which the replacement battery is used to replace, and a counterweight assembly. At least a first portion of the counterweight assembly is positioned under the replacement battery in the battery compartment. The object detection assembly comprises a first sensing device positioned in a first cutout portion of the counterweight assembly under the replacement battery. The first sensing device has an unobstructed view of one of a left or right side of the industrial vehicle. The object detection assembly further comprises a second sensing device positioned in a second cutout portion of the counterweight assembly under the replacement battery. The second sensing device has an unobstructed view of the other of the left or right side of the industrial vehicle.

The first and second sensing devices may be positioned within running lines of the vehicle.

The first and second cutout portions may be open to the respective left or right side of the industrial vehicle so as to allow for manipulation of the first and second sensing devices without removing the replacement battery or the counterweight assembly from the industrial vehicle.

The object detection assembly may further comprise a front sensor assembly including a front sensing device and a rear sensor assembly including a rear sensing device.

Each of the first, second, front, and rear sensing devices may be located within front, back, left, and right bounds of a frame of the industrial vehicle.

The first, second, front, and rear sensing devices may collectively monitor an area extending 360 degrees around the vehicle.

The counterweight assembly may include a second portion that is positioned in front of or behind the battery in the battery compartment.

A height of an operator compartment floorboard above a floor surface may be the same before and after the replacement battery is installed in the vehicle.

### BRIEF DESCRIPTION OF THE SEVERAL VIEWS OF THE DRAWINGS

FIG. 1 is a perspective view of an industrial vehicle according to embodiments;

FIG. 2 is a partial perspective view of the industrial vehicle according to embodiments;

FIG. 3 is a top view of the industrial vehicle and illustrating an object detection assembly according to embodiments;

FIG. 4 is a partial perspective view of the industrial vehicle according to embodiments;

FIG. 5A is a partial side view showing a sensor assembly and a battery compartment according to embodiments; and

FIG. 5B is a partial side view showing a sensor assembly and a battery compartment according to embodiments.

### DETAILED DESCRIPTION OF EMBODIMENTS

The following text sets forth a broad description of numerous different embodiments of the present disclosure. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. It should be understood that multiple combinations of the embodiments described and shown are contemplated and that a particular focus on one embodiment does not preclude its inclusion in a combination of other described embodiments. Numerous alternative embodiments could also be implemented, using either current technology or technology developed after the filing date of this patent, which would still fall within the scope of the claims. All publications and patents cited herein are incorporated herein by reference.

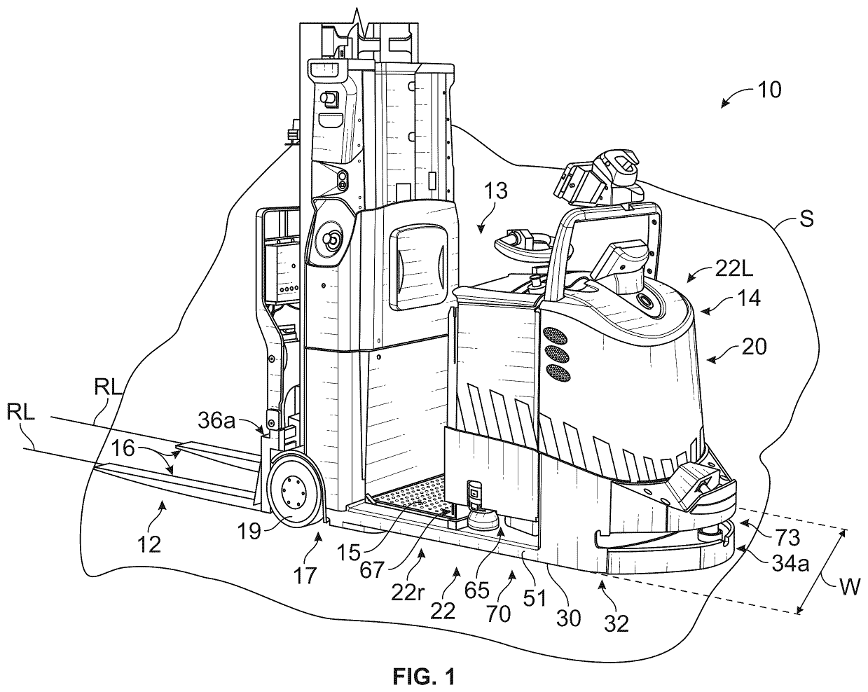

Referring now to FIG. 1 of the drawings, an exemplary industrial vehicle 10 is shown, which includes a load handling assembly 12 and a power unit 14. The load handling assembly 12 of the exemplary vehicle 10 shown includes a pair of forks 16, but it is understood that the load handling assembly 12 may include additional or alternate load handling features such as a mast, a load platform, a collection cage, and/or other structure. The exemplary vehicle 10 shown further includes an operator compartment 13, a chassis 17, a plurality of loadwheels 19, and a battery system 20. The operator compartment 13 includes a floorboard 15 on which an operator may stand while driving the vehicle 10. While the present disclosure is made with reference to the illustrated vehicle 10, it will be apparent to those of skill in the art that the embodiments disclosed herein may be used in other types of industrial vehicles, and the following description of the embodiments with reference to the Figures should not be limited to the illustrated type of vehicle 10 unless otherwise specified. Additionally, the embodiments disclosed herein may be used on vehicles that do not include a load handling assembly, such as a tugger vehicle, etc.

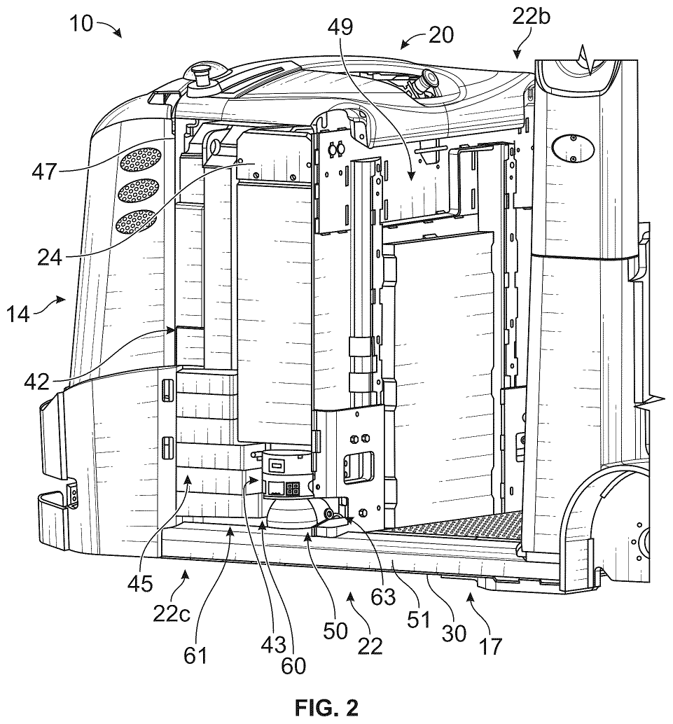

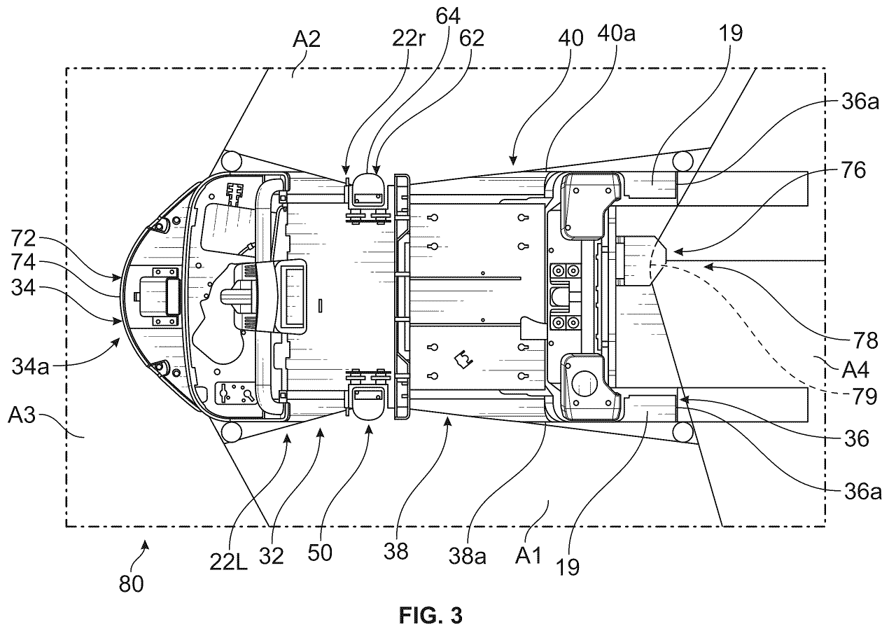

With reference now to FIGS. 2 and 3, the battery system 20 of the exemplary vehicle 10 shown includes a battery compartment 22, which houses a battery 24, and a frame 30 that defines a vehicle contour 32. The vehicle contour 32 is representative of the vehicle dimensions and may include an overall vehicle height, a floorboard height, an overall vehicle width, and an overall vehicle length. The vehicle contour 32 of the exemplary vehicle 10 is defined by front bounds 34, back bounds 36, left bounds 38, and right bounds 40 of the frame 30, wherein the left and right bounds 38, 40 are at least partially defined by opposed outermost left and right portions 38a, 40a of respective left and right sides 22L, 22r of the battery compartment 22, the front bounds 34 are defined by a front-most portion 34a of the vehicle frame 30 that extends forward of the power unit 14, and the back bounds 36 are defined by vertical faces 36a of the forks 16. The plurality of loadwheels 19 of the exemplary vehicle 10 are flush with the chassis 17 and within the vehicle contour 32, i.e., the loadwheels 19 do not increase the vehicle contour 32.

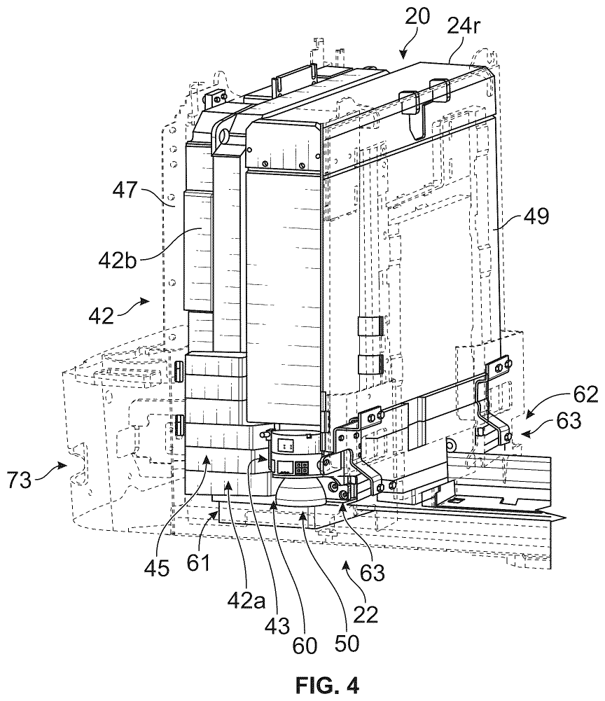

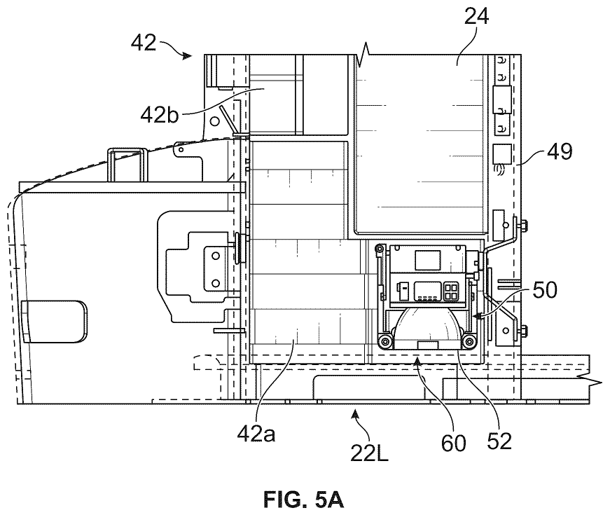

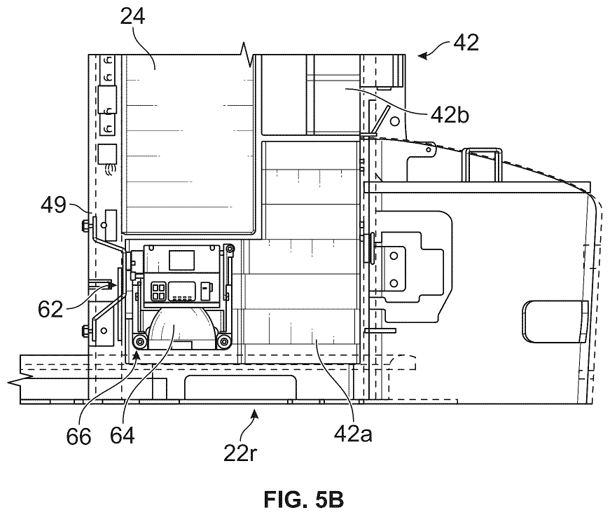

As shown in FIG. 4, the battery system 20 further includes a counterweight assembly 42, which in the exemplary embodiment shown comprises a lower counterweight 42a and an upper counterweight 42b. A first portion 43 of the lower counterweight 42a is positioned under the battery 24 and a second portion 45 of the lower counterweight 42a is positioned adjacent to the battery 24 (see FIGS. 2 and 4), such that the exemplary lower counterweight 42a takes on the appearance of an “L” shape, see FIGS. 4 and 5A. The upper counterweight 42b is positioned between and adjacent to both the battery 24 and a chassis front wall 47 and above the second portion 45 of the lower counterweight 42a. According to embodiments, the counterweight assembly 42 and battery 24 may be arranged such that their masses and centers of gravity have a positive effect on tipping stability of the vehicle 10.

With reference to FIG. 5A, the battery system 20 additionally includes a first sensor assembly 50 positioned underneath the battery 24 at one of the left or right side 22L, 22r of the battery compartment 22. The first sensor assembly 50 is positioned on the vehicle 10 such that the first sensor assembly 50 is completely located within the front, back, left, and right bounds 34, 36, 38, 40 of the frame 30 so as to not increase the vehicle contour 32. The first sensor assembly 50 includes a first sensing device 52 that monitors an area A1 adjacent to the corresponding left or right side of the vehicle 10, see FIG. 3. The first sensing device 52 may comprise, for example, a laser sensor for object detection, i.e., to detect the presence of an object within the vicinity of the vehicle 10 in the area A1. Examples of objects detected by the sensor assemblies as discussed herein include pedestrians, other industrial vehicles, racks/shelves, walls, stairs, loads, pallets, and similar objects located in a warehouse environment.

The battery system 20 of the vehicle 10 additionally includes a second sensor assembly 62 positioned underneath the battery 24 at the other of the left or right side 22L, 22r of the battery compartment 22, see FIG. 5B. Similar to the first sensor assembly 50, the second sensor assembly 62 is positioned on the vehicle 10 such that the second sensor assembly 62 is completely located within the front, back, left, and right bounds 34, 36, 38, 40 of the frame 30 so as to not increase the vehicle contour 32. The second sensor assembly 62 includes a second sensing device 64 that monitors an area A2 adjacent to the corresponding left or right side of the vehicle 10, see FIG. 3. The second sensing device 64 may comprise, for example, a laser sensor for object detection, i.e., to detect the presence of an object within the vicinity of the vehicle 10 in the area A2.

Referring now to FIGS. 4 and 5A, the counterweight assembly 42 includes a first cutout portion 60 for receiving the first sensor assembly 50, and a second first cutout portion 66 for receiving the second sensor assembly 62. The first and second cutout portions 60, 66 may each be located at least partially under the battery 24, and at least partially between the counterweight assembly 42 and a chassis rear wall 49. The first and second cutout portions 60, 66 are open to the respective left or right side of the industrial vehicle 10 to allow for manipulation of the first and second sensor assemblies 50, 62 without removing the battery 24 or the counterweight assembly 42 from the vehicle 10. For example, the first and second sensor assemblies 50, 62 may be installed, serviced, repositioned, or removed without requiring a removal of the battery 24 or the counterweight assembly 42 from the vehicle 10. This is advantageous, as it allows for quick access to the first and second sensor assemblies 50, 62 for service and/or adjustment without removal or adjustment of the battery 24 or the counterweight assembly 42. A first sensor side cutout 61 and a second sensor side cutout 63 may be located on opposing sides of the first sensor assembly 50, and a third sensor side cutout 65 and a fourth sensor side cutout 67 may be located on opposing sides of the second sensor assembly 62. The first and third sensor side cutouts 61, 65 may be formed in portions of the counterweight assembly 45 forward of the respective first and second sensor assemblies 50, 62, and the second and fourth sensor side cutouts 63, 67 may be formed in portions of the chassis rear wall 49 or vehicle skirt 51 behind the respective first and second sensor assemblies 50, 62. The side cutouts 61, 63, 65, 67 provide enlarged fields of view for the first and second sensor assemblies 50, 62.

According to embodiments, the battery 24 may be a replacement battery 24r that is smaller in at least one of a height, width, or depth dimension than an original equipment manufacturer (OEM) battery which the replacement battery 24r is used to replace. For example, the OEM battery that is replaced may be a lead acid battery, and the replacement battery may be a lithium ion (Li-ion) battery, wherein the replacement Li-ion battery is much lighter than the OEM lead acid battery and includes the same or greater energy storage capacity than the OEM lead acid battery. According to embodiments, the replacement Li-ion battery may also have a lesser energy storage capacity than the OEM lead acid battery.

According to embodiments, a height of the floorboard 15 of the operator compartment 13 and/or the surface area of the floorboard 15 may be the same before and after the replacement battery 24r is installed on the vehicle 10 to replace the OEM battery, i.e., the modifications to the vehicle 10 that are performed to install the battery system 20 including the replacement battery 24r according to the present embodiments do not change the height and/or surface area of the floorboard 15. Hence, an operator that is operating a vehicle that includes a battery system 20 according to embodiments disclosed herein does not have to become accustomed to a floorboard with a different height and/or surface area, so as to reduce or avoid a reduction in operator efficiency that could result from changing the height and/or surface area of the floorboard 15.

According to a further aspect, an object detection assembly 70 of the exemplary industrial vehicle 10 comprises the first sensor assembly 50, the second sensor assembly 62, a front sensor assembly 72, and a rear sensor assembly 76. As shown in FIG. 1, both the first sensor assembly 50 and the second sensor assembly 62 may be completely positioned within running lines RL of the vehicle 10, wherein the running lines RL are defined by outermost portions of the vehicle width W, see FIG. 1.

As shown most clearly in FIG. 3, the front sensor assembly 72 is completely located within the front, back, left, and right bounds 34, 36, 38, 40 of the vehicle frame 30 so as to not increase the vehicle contour 32. In the exemplary embodiment shown, the front sensor assembly 72 is positioned on the power unit 14, but the front sensor assembly 72 may be mounted to other components at or around the front of the vehicle 10. The front sensor assembly 72 comprises a front sensing device 74 that monitors an area A3 adjacent to the front side of the vehicle 10. The front sensing device 74 may comprise, for example, a laser sensor for object detection, i.e., to detect the presence of an object within the vicinity of the vehicle 10 in the area A3. A front cutout 73 may be provided in the front of the vehicle frame 30 to increase the area A3 sensed by the front sensing device 74.

Referring still to FIG. 3, the rear sensor assembly 76 is also completely located within the front, back, left, and right bounds 34, 36, 38, 40 of the vehicle frame 30 so as to not increase the vehicle contour 32. In the exemplary embodiment shown, the rear sensor assembly 76 is positioned under the load handling assembly 12, such as on the mast between mast rails, but the rear sensor assembly 76 may be mounted to other components at or around the rear of the vehicle 10. The rear sensor assembly 76 comprises a rear sensing device 78 that monitors an area A4 adjacent to the rear side of the vehicle 10, see FIG. 3. The rear sensing device 78 may comprise, for example, a laser sensor for object detection, i.e., to detect the presence of an object within the vicinity of the vehicle 10 in the area A4. A rear cutout 79 may be provided in the rear of the vehicle frame 30 to increase the area A4 sensed by the rear sensing device 78.

Together, the first sensor assembly 50, the second sensor assembly 62, the front sensor assembly 72, and the rear sensor assembly 76 of the object detection assembly 70 monitor 360 degrees around the vehicle 10, i.e., the collective areas A1, A2, A3, and A4 monitored by the respective first, second, front, and rear sensor assemblies 50, 62, 72, 76 completely cover the area 360 degrees around the vehicle 10, without increasing the vehicle contour 32. That is, each of the first, second, front, and rear sensor assemblies 50, 62, 72, 76 are positioned on the vehicle 10 completely within the vehicle contour 32 and within the running lines RL of the vehicle 10, see FIG. 1.

The battery system 20 and/or the object detection assembly 70 may be original feature(s) included on a newly manufactured industrial vehicle or may be utilized when modifying or to retrofit an industrial vehicle already in use to include the battery system 20 and/or the object detection assembly 70. For example, the currently in use vehicle may be modified by either altering the battery compartment or replacing the battery compartment with a replacement battery compartment (not shown). The altered/replacement battery compartment may also be configured to receive the replacement battery 24r that is smaller in at least one of a height, width, or depth dimension and lighter in weight than an original equipment manufacturer (OEM) battery 24 which the replacement battery 24r is used to replace. It is also contemplated that the currently in use vehicle may be modified by replacing the OEM battery 24 with the replacement battery 24r, wherein the extra space that is available in the battery compartment 22 due to the replacement battery 24r being smaller in at least one of the height, width, or depth dimension than the OEM battery 24 can be used to accommodate the counterweight assembly 42 and the first and second cutout portions 60, 66. Additionally or alternatively, the first sensor assembly 50 and the second sensor assembly 62 may be added to the vehicle, for example, in the first and second cutout portions 60, 66, respectively, and the front and rear sensor assemblies 72, 76 may be respectively added to the front and rear of the vehicle 10. It is also contemplated that the front and rear sensor assemblies 72, 76 may already be present on the currently in use vehicle, in which case only the first and second sensor assemblies 50, 62 need to be added to complete the object detection assembly 70.

Industrial vehicles are frequently used in warehouses or distribution centers that include tight spaces, as well as many other moving objects, such as people or other industrial vehicles. An industrial vehicle including the features discussed herein, i.e., the battery system 20 and/or the object detection assembly 70, provides the benefit of maintaining and/or increasing the efficiency of the industrial vehicle in tight spaces. Having the ability to monitor 360 degrees around the vehicle, without increasing the vehicle contour, provides the benefit of obstacle detection/avoidance without compromising the ability to operate the vehicle in such tight spaces. As discussed above, the object detection assembly 70 and the battery system 20 may be included on a newly manufactured industrial vehicle, or may be utilized when modifying or to retrofit an existing industrial vehicle already in use. This is of particular importance if an existing vehicle does not include an object detection system. By modifying an existing vehicle to include the battery system 20 and/or the object detection assembly 70, the existing vehicle obtains the capability to monitor 360 degrees around the vehicle without increasing the vehicle contour 32, or changing the height of the operator platform floorboard. Such an increase in the vehicle contour and/or change to the height of the operator platform floorboard would otherwise make the vehicle more cumbersome, interfere with the ability of the vehicle to perform at peak efficiency, and/or hinder the operator's efficiency of operation of the vehicle. According to embodiments disclosed herein, having a vehicle that includes 360 degree monitoring around the vehicle while maintaining the vehicle contour allows the vehicle to perform normal functions unhindered, such as moving through narrow aisles and maneuvering around objects, people, and other industrial vehicles.

Having thus described embodiments of the present application in detail and by reference to embodiments thereof, it will be apparent that modifications and variations are possible without departing from the scope of the appended claims.

What is claimed is:

1. A battery system for an industrial vehicle, the industrial vehicle including a frame having a vehicle contour defined by front, back, left, and right bounds of the frame, the left and right bounds at least partially defined by opposed outermost left and right portions of respective left and right sides of a battery compartment, the battery system comprising:
a battery housed in the battery compartment;
a counterweight assembly, wherein at least a portion thereof is positioned underneath the battery; and
a first sensor assembly positioned underneath the battery at one of the left or right side of the battery compartment, wherein the first sensor assembly is completely located within the front, back, left, and right bounds of the frame so as to not increase the vehicle contour;
wherein the first sensor assembly includes a sensing device that monitors an area adjacent to the corresponding left or right side of the vehicle.

2. The battery system of claim 1, wherein the battery is a replacement battery that is smaller in at least one of a height, width, or depth dimension than an original equipment manufacturer (OEM) battery which the replacement battery is used to replace.

3. The battery system of claim 1, wherein the counterweight assembly includes a first cutout portion for receiving the first sensor assembly, wherein the first cutout portion allows for manipulation of the first sensor assembly without removing the battery or the counterweight assembly from the industrial vehicle.

4. The battery system of claim 1, further comprising a second sensor assembly positioned underneath the battery at the other of the left or right side of the battery compartment, wherein the second sensor is completely located within the front, back, left, and right bounds of the frame so as to not increase the vehicle contour, wherein the second sensor assembly includes a sensing device that monitors an area adjacent to the corresponding left or right side of the vehicle.

5. The battery system of claim 4, wherein the counterweight assembly includes a first cutout portion for receiving the first sensor assembly and a second cutout portion for receiving the second sensor assembly, wherein the first and second cutout portions allow for manipulation of the first sensor assembly and second sensor assembly without removing the battery or the counterweight assembly from the industrial vehicle.

6. The battery system of claim 4, further comprising a first sensor side cutout and a second sensor side cutout located on opposed sides of the first sensor assembly for enlarging the field of view of the first sensor assembly.

7. The battery system of claim 6, further comprising a third sensor side cutout and a fourth sensor side cutout located on opposed sides of the second sensor assembly for enlarging the field of view of the second sensor assembly.

8. The battery system of claim 1, wherein a height of an operator compartment floorboard above a floor surface is the same before and after the battery is installed in the vehicle.

9. The battery system of claim 1, wherein a surface area of an operator compartment floorboard is the same before and after the replacement battery is installed in the vehicle.

10. An object detection assembly for an industrial vehicle, the industrial vehicle including a battery compartment, a replacement battery that is smaller in at least one of a height, width, or depth dimension than an original equipment manufacturer (OEM) battery which the replacement battery is used to replace, and a counterweight assembly, wherein at least a first portion of the counterweight assembly is positioned under the replacement battery in the battery compartment, the object detection assembly comprising:
a first sensing device positioned in a first cutout portion of the counterweight assembly under the replacement battery, the first sensing device having an unobstructed view of one of a left or right side of the industrial vehicle; and
a second sensing device positioned in a second cutout portion of the counterweight assembly under the replacement battery, the second sensing device having an unobstructed view of the other of the left or right side of the industrial vehicle.

11. The object detection assembly of claim 10, wherein the first and second sensing devices are each positioned within running lines of the vehicle.

12. The object detection assembly of claim 10, wherein the first and second cutout portions are open to the respective left or right side of the industrial vehicle so as to allow for manipulation of the first and second sensing devices without removing the replacement battery or the counterweight assembly from the industrial vehicle.

13. The object detection assembly of claim 12, further comprising a first sensor side cutout and a second sensor side cutout located on opposed sides of the first sensing device for enlarging the field of view of the first sensing device.

14. The object detection assembly of claim 13, further comprising a third sensor side cutout and a fourth sensor side cutout located on opposed sides of the second sensing device for enlarging the field of view of the second sensing device.

15. The object detection assembly of claim 10, further comprising a front sensor assembly including a front sensing device and a rear sensor assembly including a rear sensing device.

16. The object detection assembly of claim 15, wherein each of the first, second, front, and rear sensing devices is located within front, back, left, and right bounds of a frame of the industrial vehicle.

17. The object detection assembly of claim 15, further comprising a front cutout provided in the front of the frame adjacent to the front sensing device for enlarging the field of view of the front sensing device and a rear cutout provided in the back of the frame adjacent to the rear sensing device for enlarging the field of view of the rear sensing device.

18. The object detection assembly of claim 15, wherein the first, second, front, and rear sensing devices collectively monitor an area extending 360 degrees around the vehicle.

19. The object detection assembly of claim 10, wherein the counterweight assembly includes a second portion that is positioned in front of or behind the replacement battery in the battery compartment.

20. The object detection assembly of claim 10, wherein at least one of:
a height of an operator compartment floorboard above a floor surface is the same before and after the replacement battery is installed in the vehicle or a surface area of an operator compartment floorboard is the same before and after the replacement battery is installed in the vehicle.
